(19) United States
(12) Patent Application Publication
(10) Pub. No.: US 2023/0131883 A1
(43) Pub. Date: Apr. 27, 2023

(54) METHOD FOR REMOVING ETHYLENE FROM AGRICULTURAL PRODUCTS

(71) Applicant: COMPACT MEMBRANE SYSTEMS, INC., Newport, DE (US)

(72) Inventors: STUART MARSHALL NEMSER, Wilmington, DE (US); SUDIPTO MAJUMDAR, Newark, DE (US); NING SHANGGUAN, Cherry Hill, NJ (US)

(21) Appl. No.: 17/914,152

(22) PCT Filed: Mar. 26, 2021
(86) PCT No.: PCT/US2021/024269

§ 371 Date: Sep. 23, 2022

Related U.S. Application Data
(60) Provisional application No. 63/002,015, filed on Mar. 30, 2020.

(51) Int. Cl. B01D 53/22; B01D 69/12; B01D 71/66; B01D 71/32; A23B 7/148; B01D 71/02

(52) U.S. Cl. CPC B01D 53/229; B01D 69/12; B01D 71/66; B01D 71/32; A23B 7/148; B01D 71/022

(57) ABSTRACT

A method for removing ethylene from the atmosphere surrounding an agricultural product that is sensitive to ethylene, which promotes climacteric ripening and senescence, is disclosed. The method uses a membrane for selective ethylene permeation and removal from a container that is used to store, transport, and preserve the agricultural product.

### CROSS REFERENCE TO RELATED APPLICATIONS

This application claims the benefit of priority to U.S. provisional patent application No. 63/002,015 filed on Mar. 30, 2020; the entirety of which is hereby incorporated by reference herein.

### GOVERNMENT RIGHTS

This invention was made with government support under 2019-33610-29759 awarded by the United States Department of Agriculture. The government has certain rights in the invention.

### FIELD OF THE INVENTION

A method for removing ethylene from the atmosphere surrounding an agricultural product in a container using a membrane.

### BACKGROUND

Ethylene is a gaseous hormone for plants, especially fruits, vegetables, and flowers. It is generated by plants themselves and promotes and coordinates the physiological process of climacteric ripening and senescence in many fruit, vegetable and floricultural plant types. Uncontrolled ethylene exposure was shown to be a significant contributor to losses in postharvest quality for these items. For example, ethylene levels in the range of 0.1 to 20 ppm have an undesirable effect on the quality of kiwifruits, bananas, broccoli, and spinach by hastening the softening of the kiwi and banana pulp, and by promoting chlorophyll loss in broccoli florets and spinach leaves. K. G. Hee et al. in “Interaction of enhanced carbon dioxide and reduced ethylene on the storage of strawberries”, J. of Horticultural Science and Biotechnology, 73 [2] (1998) 181-184 showed that removal of ethylene using an absorbent improved strawberry storage life, which improved logarithmically with decreasing ethylene concentration. R. B. H. Wills et al. in “Importance of ethylene on non-climacteric fruit and vegetables”, Proceedings of Australian Post harvest Horticulture Conference, (1996) 59-61, showed that the storage life of strawberries, lettuce, and beans was extended by lowering ethylene concentrations from 10 to 0.005-mg/L. Likewise, oranges stored in ethylene-free air have a lower decay rate and better skin appearance. Similar results have been shown by others for apples, guava, avocado, nectarines, pears, grapefruit, cherries, cherimoya, and flowers.

Significant effort and costs normally go into the control of ethylene and the slowing of plant metabolism and ripening during shipping and storage of commercial agricultural products. This has included temperature control through refrigeration, use of ethylene absorbents, and in some cases, controlled atmosphere storage such as by having reduced oxygen and elevated nitrogen or carbon dioxide concentrations to form a controlled container atmosphere that is surrounding the agricultural products. Alternative methods that are non-chemical, less energy and capital intensive for removal of ethylene as it is generated could play a central role in maintaining the freshness of fruit, vegetable, and flower products and ensure that these agricultural products can be shipped longer distances and stored over extended times.

### SUMMARY OF THE INVENTION

This invention provides a method for removing ethylene from the container atmosphere surrounding an agricultural product using a membrane. The method comprises:
1. providing a container comprising an agricultural product configured therein and a container atmosphere; and
2. providing a membrane that is permeable to ethylene; and
3. contacting said membrane with said container atmosphere to permeate ethylene from the container atmosphere.

Use of a membrane for ethylene permeation and its removal from the container atmosphere in the container can help to slow down ripening and senescence processes in an agricultural product. The membrane may also help to slow the loss of certain volatile aroma (volatile component of flavor) molecules emanating from the agricultural product. The membrane may be used in conjunction with other preservation techniques that include controlled atmosphere storage, refrigeration, and ethylene absorbents, and can help to maintain a low oxygen concentration in a controlled container atmosphere. A controlled atmosphere storage container may have an oxygen concentration that is reduced, such as being reduce from the oxygen concentration just outside of the container or below atmospheric oxygen concentration of about 20%. The oxygen concentration may be reduced to about 18% or less, about 15% or less, about 10% or less or even about 5% or less and any range between and including the reduced oxygen concentrations listed. Lower oxygen concentrations may result in slower plant metabolism and ripening during shipping. The nitrogen concentration within the controlled atmosphere of the storage container may be increase due to the reduction of oxygen, and may be higher than atmospheric nitrogen concentrations of about 80%. The elevated nitrogen concentration may be about 85% or more, about 90% or more, about 95% or more and any range between and including the elevated nitrogen concentrations listed. This may reduce energy requirements for maintaining a refrigerated storage container atmosphere since it is predominantly ethylene (and possibly oxygen) that permeates the membrane and significantly less of the major components of the container atmosphere such as nitrogen. A controlled atmosphere storage container may be refrigerated to a temperature below the temperature surrounding or just outside of the storage container, such as less than standard room temperature of about 20° C.

Potential applications of the invention include use in containers that can be packaging, cargo containers that are used to ship agricultural products long distances, and warehouses that are used to store the agricultural products for subsequent distribution. A container may be a storage container, a shipping container, a container within a refrigerator and the like. Removal of ethylene is anticipated to help extend storage life by reducing the rate of deterioration and maintain product quality under many postharvest storage or transport scenarios.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. In addition, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein. The described embodiments are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention. Certain additional terms are also used and some of them are further defined within the following detailed description of the invention.

### BRIEF DESCRIPTION OF THE DRAWINGS

The accompanying figures are included to provide a further understanding of the invention and are incorporated in and constitute a part of this specification. The figures illustrate embodiments of the invention and together with the description serve to explain the principles of the invention. Corresponding reference characters indicate corresponding parts throughout the several views of the figures. The figures represent an illustration of some of the embodiments of the present invention and are not to be construed as limiting the scope of the invention in any manner. Furthermore, the figures are not necessarily to scale and some features may be exaggerated to show details of particular components. Also, specific structural and functional details disclosed herein are not to be interpreted as limiting, but merely as a representative basis for teaching one skilled in the art to variously employ the present invention.

FIG. 1 illustrates ethylene removal from a container atmosphere surrounding agricultural products that are stored in a container, which incorporates a membrane that is permeable to ethylene.

FIG. 2 illustrates ethylene removal through recirculation of the container atmosphere from a container, which contains agricultural products, across a membrane that is permeable to ethylene.

FIG. 3 illustrates ethylene removal through recirculation of the container atmosphere from a container, which contains agricultural products, across a membrane that is permeable to ethylene, and additionally comprises in-series recirculation through an oxygen selective membrane to generate or maintain a controlled atmosphere that is oxygen depleted.

### DETAILED DESCRIPTION OF THE INVENTION

This invention discloses novel methods for ethylene removal from the container atmosphere surrounding an agricultural product in a container using an ethylene permeable membrane. In one embodiment, the container or packaging holding the agricultural product may incorporate the ethylene permeable membrane as a permeable window. In another embodiment, the ethylene permeable membrane may form the majority of the container such as the packaging. In other embodiments, the ethylene permeable membrane is also permeable to oxygen and may be highly permeable to water vapor such that it may assist with humidity control within the container atmosphere. The ethylene permeable membrane may form all or a part of the packaging for the agricultural product or it may be a component of a larger storage or shipping container and connected to the container atmosphere within or external to the container through use of any combination of pumps, compressors, blowers, conduits, and recycle loops. The invention may also be used in conjunction with other preservation strategies that include refrigeration, ethylene absorbents, and controlled atmospheres having reduced oxygen concentrations in which the major component of the container atmosphere is nitrogen-enriched air, nitrogen, or carbon dioxide.

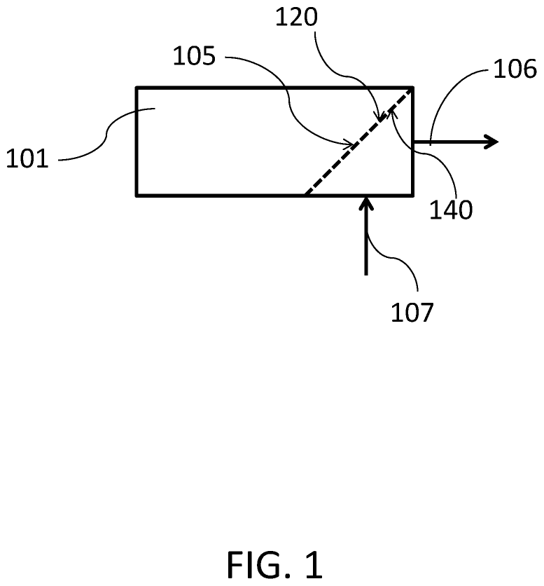

FIG. 1 illustrates one embodiment for ethylene removal from a container atmosphere surrounding agricultural products that are stored in a container 101. The container 101 incorporates a membrane 105, which is permeable to ethylene, and the permeated ethylene from the container atmosphere exits the container 101 through conduit 106. The membrane has a retentate side 120 in contact with the container atmosphere and a permeate side 140. A permeate sweep, such as from a flow of air, nitrogen-enriched air, or nitrogen may be applied through a sweep conduit 107 to reduce the concentration of permeated ethylene and increase membrane 105 efficiency. The permeate sweep using nitrogen-enriched air or nitrogen may also be used to reduce or maintain a lower oxygen concentration in a controlled container atmosphere within the container 101 if the membrane 105 is also permeable to oxygen.

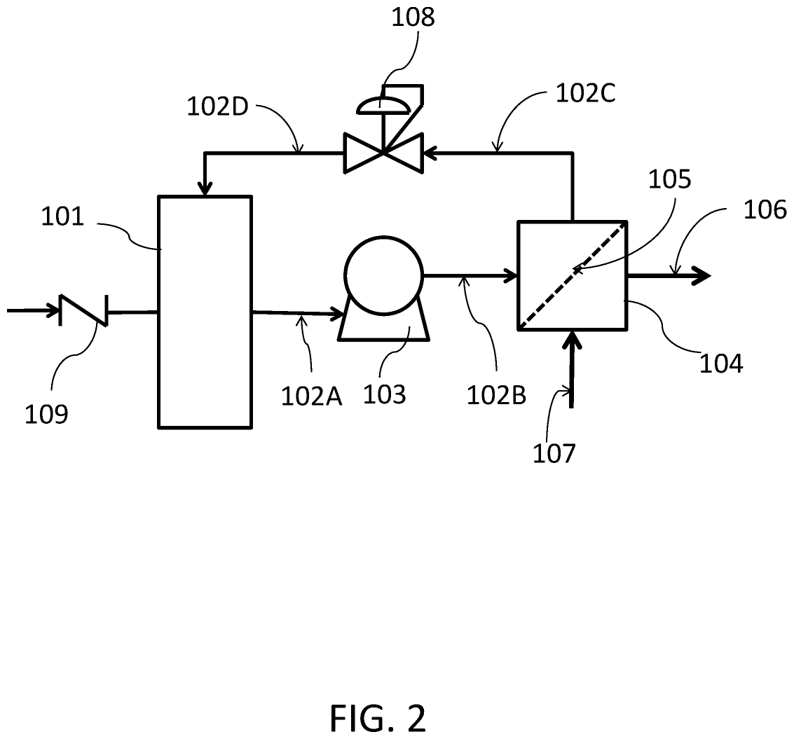

FIG. 2 illustrates another embodiment for ethylene removal through recirculation of a container atmosphere from a container 101, which contains agricultural products, across membrane 105, which is permeable to ethylene. The container atmosphere flows through conduit 102A and its pressure is increased by compressor 103, to produce a compressed container atmosphere. The compressed container atmosphere is fed through conduit 102B into membrane housing 104, where ethylene is separated (permeated) using membrane 105. The separated ethylene exits membrane housing 104 through conduit 106. A permeate sweep, such as from air, nitrogen-enriched air, or nitrogen, may be applied through sweep conduit 107 to reduce the permeated ethylene concentration and increase membrane 105 efficiency. The permeate sweep using nitrogen-enriched air or nitrogen may also be used to reduce or maintain a lower oxygen concentration in a controlled container atmosphere within the container 101 if the membrane 105 is also permeable to oxygen. The compressed container atmosphere, which is depleted of ethylene, exits membrane housing 104 through conduit 102C and its pressure may be reduced using a backpressure regulator 108 before returning to container 101 through conduit 102D. An air, nitrogen-enriched, or other controlled atmosphere bleed 109 may be used to maintain close to atmospheric pressure within the container 101.

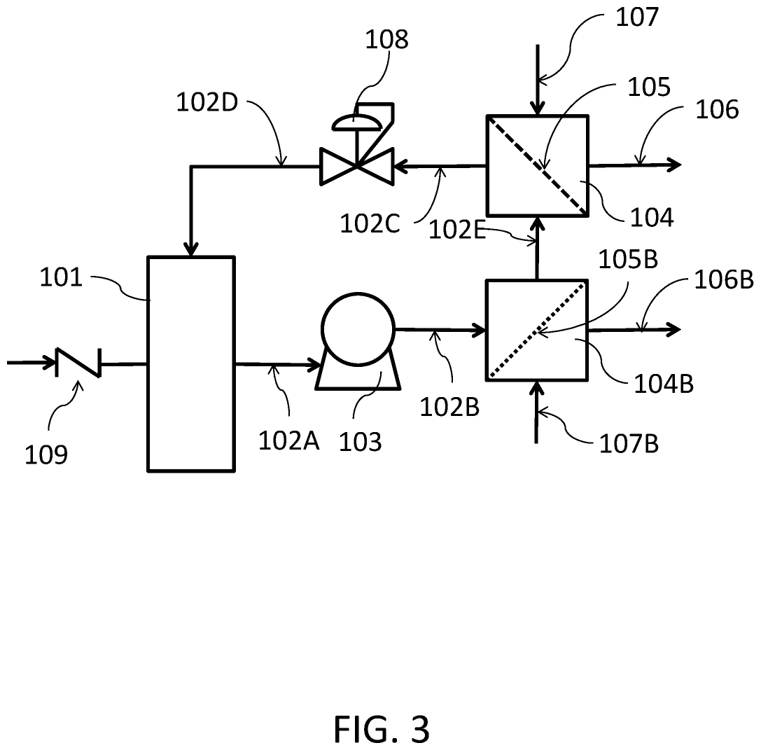

FIG. 3 illustrates another embodiment for ethylene removal with recirculation of the container atmosphere and separate in-series removal of oxygen and ethylene to generate or maintain a controlled container atmosphere that is oxygen depleted. The container atmosphere in container 101, holding agricultural products, flows through conduit 102A and its pressure is increased by compressor 103, to produce a compressed container atmosphere. The compressed container atmosphere flows through conduit 102B into enrichment membrane housing 104B, where oxygen is separated (permeated) using enrichment membrane 105B reducing the oxygen concentration in the compressed container atmosphere relative to other gases. Enrichment membranes 105B, that are useful for separation of oxygen from nitrogen in the invention, include PRISM® membranes (Air Products, St Louis, Mo.). The separated oxygen exits membrane housing 104B through conduit 106B. A permeate sweep, which may consist of air, nitrogen enriched air, or nitrogen, is optionally applied through sweep conduit 107B to increase enrichment membrane 105B efficiency. The compressed container atmosphere now depleted of oxygen, flows through conduit 102E into membrane housing 104, where ethylene is separated (permeated) using membrane 105. The separated ethylene exits membrane housing 104 through conduit 106. A permeate sweep, such as from a flow of air, nitrogen enriched air, or nitrogen, is optionally applied through sweep conduit 107 to reduce the separated ethylene concentration and increase membrane 105 efficiency. The compressed container atmosphere, depleted of oxygen and ethylene, exits membrane housing 104 through conduit 102C and its pressure may be reduced using a backpressure regulator 108 before returning to container 101 through conduit 102D. An air, nitrogen-enriched, or other controlled atmosphere bleed 109 may be used to maintain close to atmospheric pressure within the container 101.

Membranes that are useful in the invention are at least permeable to the ethylene in the container atmosphere surrounding agricultural products. The membrane may be permeable to other gases in the container atmosphere such as water vapor, nitrogen, oxygen, or carbon dioxide. The membrane is preferably more permeable to ethylene and water vapor than to nitrogen, oxygen, carbon dioxide, or other gases. Membranes that are facilitated-transport membranes are well known in the art and can be much more permeable to ethylene (and water vapor) over most other gases. Facilitated-transport membranes usually contain agents which help to increase the solubility of ethylene in the membrane through reversible reaction or complexation mechanisms and selectively “facilitate” ethylene transport across the membrane. For example, agents can include group 11 metal ions or metal salts such as silver ions or silver salts that contain silver ions. The ions may be electrostatically bound within the facilitated-transport membrane. The facilitated-transport membrane may be monolithic or preferably part of a composite membrane incorporating multiple layers that include a non-porous separation layer comprising the agent within a polymeric-membrane matrix material, and other layers that may include a non-porous gutter layer, and a porous-layer support.

A non-porous gutter layer may be used to increase overall permeance of the composite membrane and may help to enable formation of the thin separation layer mostly on top of the composite rather than significantly within the pores of the porous-layer support. The gutter layer is highly permeable to ethylene but is usually much less selective in that other gases also have relatively high permeance. The gutter layer may be fabricated from materials that are polymers such as Teflon® AF 2400 (The Chemours Company, Wilmington, Del.) or certain silicone rubbers such as poly(trimethyl-silyl)propyne. The gutter layer may be fabricated by solution casting and preferred casting techniques include but are not limited to ring casting, dip coating, spin-coating, slot-die coating, and Mayer rod coating. The gutter layer preferably has an ethylene permeance of at least 200-GPU at 25° C. Permeance, which is pressure normalized flux, is typically reported in gas permeance units or GPU and has units of 10⁶×cm³(STP)/cm²/sec/cmHg. Permeability is further normalized for thickness and has units of 10¹⁰×cm³(STP)×cm/cm²/sec/cmHg and reported in Barrer. The gutter layer is usually sandwiched between the separation layer and a porous support.

The porous-layer support, which is usually much thicker compared to the other layers, reinforces the separation and gutter layer (if included) and helps to strengthen the composite membrane as a whole such that the membrane may be fabricated into more complex geometries such as spiral-wound or hollow-fiber membrane modules. The porous-layer support may be in the form of a flat sheet, hollow fiber, or tube. Suitable materials for a porous-layer support include but are not limited to polyvinylidine fluoride, expanded polytetrafluoroethylene, polyacrylonitrile, polysulfone, and polyethersulfone. The porous-layer support may also comprise an even stronger backing material such as porous non-woven polyester or polypropylene. Porous inorganic substrates such as silica or alumina are also suitable materials for the porous-layer support. Permeate gases should flow relatively unobstructed through the usually much thicker porous-layer support. The porous-layer support has a preferred porosity that is 40% or greater. The average pore size is preferably less 0.1-μm and more preferably between 0.01 and 0.03-μm.

The non-porous separation layer in a facilitated-transport membrane may be fabricated from polymeric materials that are ionomers. Ionomers are highly useful in the invention and are copolymers that comprise both electrically neutral repeating units and repeat units having ionic groups, such as sulfonate or carbon/late groups. The ionic groups are hydrophilic and also enable a high water vapor permeance. Ionomers containing sulfonate groups are preferred and include non-fluorinated ionomers such as sulfonated polystyrene, sulfonated polyether ketone, sulfonated polyphenylene sulfide, or sulfonated polysulfone. Ionomers that are fluorinated or perfluorinated are very preferred and include ionomers from copolymers having repeat units from tetrafluoroethylene and a perfluorovinylether, having a pendant sulfonate group. Examples of perfluorinated ionomers include Aquivion® (Solvay, Houston, Tex.) or Nafion® (The Chemours Company, Wilmington, Del.). Fluorinated and perfluorinated ionomers were previously noted for their applications in facilitated-transport membranes for separation of alkenes from alkanes and other gases and have been disclosed in Eriksen et al., “Use of silver-exchanged ionomer membranes for gas separation,” U.S. Pat. No. 5,191,151; Feiring, A. E. et al., “Membrane separation of olefin and paraffin mixtures,” U.S. Pat. No. 10,029,248; and Wu, M. L., “Gas separations using membranes comprising perfluorinated polymers with pendant ionomeric moieties,” U.S. Pat. No. 4,666,468.

### EXAMPLES

### Example 1

As represented in FIG. 1, a model cylindrical storage container having a 3780-cm³ volume (V_{c}) and a 45.6-cm² opening area (A) was constructed from a high-density polyethylene (HDPE) container. A composite membrane having a fluorinated separation layer was prepared as disclosed in Feiring, A. E. et al., “Membrane separation of olefin and paraffin mixtures,” U.S. Pat. No. 10,029,248. The membrane was sealed over the container opening with the separation layer “feed side” facing the storage container volume. The membrane permeate-side was loosely covered with an inverted funnel and the funnel stem was connected to an air sweep (4-L/min) that was humidified by passing the air through a water bubbler, ahead of the funnel. In separate experiments, 600 ppm of ethylene in air or nitrogen was added to the container. Gas samples (3.0-mL) were taken through the septum port and periodically analyzed by gas chromatography (GC).

Ethylene permeance measurements were made using a constant volume/variable pressure technique. GC peak areas were proportional to ethylene partial pressure (Pᵤₚ) in the container. Permeance through the container walls and the permeate partial pressure (P_{down}) in the large sweep were negligible (i.e. P_{down}<<Pᵤₚ). GC peak areas with time were modeled to an exponential decay to estimate a decay rate constant (k) and calculate permeance (GPU), having units of 10⁶×cm³ (STP)/cm²/sec/cmHg, according to equation (1):

$$Permeance ( GPU ) = {10}^{6} \frac{{V}_{c}}{RTA \times ( {P}_{up} - {P}_{down} )} \times - \frac{dP}{dt} = {10}^{6} \frac{{V}_{c} k}{RTA} \qquad ( 1 )$$

where R is a gas constant (0.278 cm³ cmHg/(cm³ (STP) K), and T is the experimental temperature (Kelvin). Ethylene concentration decreased with a half-life of 25 to 40 minutes and ethylene permeance was between 290 to 460 GPU in air or nitrogen respectively. Nitrogen and oxygen permeance were measured separately in experiments using a pressurized cross-flow cell (humidified feed). Nitrogen permeance was less than 3 GPU and oxygen permeance was approximately 5 GPU.

### Example 2

A composite membrane having an ionomer separation layer of the silver salt of sulfonated polystyrene was prepared as further described. A 30% solution of polystyrene sulfonic acid in water (Sigma-Aldrich) was diluted with 2-propanol to 3%. The solution was stirred overnight with 2 molar equivalents of silver carbonate to sulfonic acid groups. The solution was subsequently filtered using a 1-μm glass microfiber syringe filter to remove excess silver carbonate. The polystyrene silver sulfonate solution was ring-cast onto a previously prepared poly(trimethylsilyl)propyne gutter layer on a polyvinylidine fluoride PVDF porous support. Excess solution was pipetted away and the remaining liquid film was dried for several hours at ambient room temperature in a low humidity atmosphere to form the separation layer. The resulting composite membrane was sealed over the opening of the container as described in example 1, with the separation layer “feed side” facing the storage container volume, and tested in a similar fashion using a humidified air sweep. 1100 ppm of ethylene in nitrogen enriched air (1.2% oxygen) was added to the container. Gas samples (3.0-mL) were taken through the septum port and periodically analyzed by gas chromatography (GC). Ethylene concentration decreased with a half-life of 21 minutes and ethylene permeance was 614 GPU. A slowly increasing oxygen concentration was measured using an oxygen monitor within the container and the calculated oxygen permeance was 11 GPU.

### Example 3

A composite membrane having a separation layer of Teflon® AF 2400 was prepared as further described. A 0.5% solution of Teflon® AF 2400 in Novec® FC770 was prepared and filtered using a 1-μm glass microfiber syringe filter. The solution was ring-cast onto a polyvinylidine fluoride PVDF porous support. Excess solution was pipetted away and the remaining liquid film was dried for several hours at ambient room temperature in a low humidity atmosphere to form the Teflon® AF 2400 separation layer. The resulting composite membrane was sealed over the opening of the container as described in example 1, with the separation layer “feed side” facing the storage container volume, and tested in a similar fashion using a humidified nitrogen sweep. 1200 ppm of ethylene in air was added to the container. Gas samples (3.0-mL) were taken through the septum port and periodically analyzed by gas chromatography (GC). Ethylene concentration decreased with a half-life of 43 minutes and ethylene permeance was 270 GPU. The oxygen concentration in the container decreased with a half-life of 30 minutes and oxygen permeance was 372 GPU.

### Example 4

A composite membrane having an ionomer separation layer of the silver salt of Aquivion® was prepared as further described. A 25% solution of Aquivion® D72-25BS in water (Sigma-Aldrich) was diluted with 2-propanol to 2%. The solution was stirred overnight with 2 molar equivalents of silver carbonate to sulfonic acid groups. The solution was subsequently filtered using a 1-μm glass microfiber syringe filter to remove excess silver carbonate. The Aquivion® solution was ring-cast onto a previously prepared Teflon® AF 2400 separation layer (now a gutter layer) on a polyvinylidine fluoride PVDF porous support as described in example 3. Excess solution was pipetted away and the remaining liquid film was dried for several hours at ambient room temperature in a low humidity atmosphere to form the ionomer separation layer. The resulting composite membrane was sealed over the opening of the container as described in example 1, with the separation layer “feed side” facing the storage container volume, and tested in a similar fashion using a humidified nitrogen sweep. 600 ppm of ethylene in nitrogen enriched air (1.7% oxygen) was added to the container. Gas samples (3.0-mL) were taken through the septum port and periodically analyzed by gas chromatography (GC). Ethylene concentration decreased with a half-life of 30 minutes and ethylene permeance was 454 GPU. The oxygen concentration in the container was measured using an oxygen monitor and remained at 1.7% during the course of the experiment.

What is claimed is:

1. A method for removing ethylene from a container atmosphere surrounding an agricultural product that is in a container, the method comprising:
a) providing said container comprising said agricultural product configured therein, and said container atmosphere; and
b) providing a membrane that is permeable to ethylene; and
c) permeating ethylene from the container atmosphere using said membrane.

2. The method of claim 1, further providing a sweep conduit and producing-a flow of sweep gas over the membrane.

3. The method of claim 1, wherein the membrane is configured in the container.

4. The method of claim 1, wherein contacting said container atmosphere with said membrane comprises recirculating said container atmosphere between said container and said membrane.

5. The method of claim 4, further providing a compressor and compressing said container atmosphere to produce a compressed container atmosphere.

6. The method of claim 4, further providing an enrichment membrane that is permeable to oxygen and configured between the container and said membrane.

7. The method of claim 6, further providing a sweep conduit and producing a flow of sweep gas over the enrichment membrane.

8. The method of claim 1, wherein the membrane is permeable to oxygen.

9. The method of method of claim 1, wherein the membrane is permeable to water vapor.

10. The method of method of claim 1, wherein the container atmosphere comprises an oxygen concentration that is less than atmospheric oxygen concentration of 20%.

11. The method of method of claim 10, wherein the container atmosphere comprises nitrogen-enriched air having a nitrogen concentration that is higher than atmospheric of 80%.

12. The method of claim 1, wherein the container atmosphere is refrigerated.

13. The method of method of claim 1, wherein the container comprises an ethylene absorbent.

14. The method of method of claim 1, wherein the membrane is a facilitated-transport membrane.

15. The method of claim 14, wherein the facilitated-transport membrane is a composite membrane having more than one layer.

16. The method of claim 14, wherein the facilitated-transport membrane comprises a silver ion or a silver salt that contains a silver ion.

17. The method of claim 14, wherein the facilitated-transport membrane comprises an ionomer select from a group consisting of: a non-fluorinated ionomer, a fluorinated ionomer, or a perfluorinated ionomer.

18. The method of claim 17, wherein the ionomer comprises sulfonate groups.

19. The method of claim 1, wherein the container is a storage or shipping container.

20. The method of claim 1, wherein the agricultural product is selected from a group consisting of: kiwifruits, bananas, broccoli, spinach, apples, oranges, guava, avocado, nectarines, pears, grapefruit, cherries, cherimoya, strawberries, lettuce, beans, and cut flowers.
